(19) United States
(12) Patent Application Publication
(10) Pub. No.: US 2026/0144406 A1
(43) Pub. Date: May 28, 2026

(54) Rack Support System For A Cooking Apparatus

(71) Applicant: Premier Specialty Brands LLC, Chamblee, GA (US)

(72) Inventor: Anthony Hardy, Columbus, GA (US)

(73) Assignee: Premier Specialty Brands LLC, Chamblee, GA (US)

(21) Appl. No.: 18/926,697

(22) Filed: Oct. 25, 2024

(51) Int. Cl. A47J 37/06; A23B 4/052

(52) U.S. Cl. CPC A47J 37/0694; A23B 4/052

(57) ABSTRACT

The present disclosure comprises inventive systems, methods, and apparatuses for positioning and securing a rack of a cooking apparatus. To that end, an improved support bracket may comprise a support shelf extending generally horizontally relative to a side wall of the cooking apparatus, a guide shelf positioned above the support shelf, and a spring band disposed between the support shelf and the guide shelf. The rack support systems and apparatuses are advantageous because they allow for “automatic” centering and securing of a rack of a cooking apparatus when in use while still allowing easy insertion or removal of the rack by the user.

### TECHNICAL FIELD

The present disclosure relates generally to systems, methods, and apparatuses for positioning and securing a rack of a cooking apparatus and, more particularly, inventive support brackets that can secure and center a rack of a cooking apparatus while still allowing for easy insertion or removal of the rack by a user.

### BACKGROUND OF THE DISCLOSED EMBODIMENTS

Many cooking apparatuses require placing food on a rack (e.g., a cooking rack, warming rack, smoking rack, grilling rack, etc.) located above a heat source inside or above a cooking chamber. The heat source generates heat, and in some instances smoke, which rises towards the rack to cook or warm the food on the rack. Various types of cooking apparatuses incorporate such racks, including for example grills, smokers, stoves, and ovens. Cooking apparatuses may include various types of heat sources, such as a gas burner, an electric burner, or a fire created by burning a combustible solid fuel (e.g. charcoal, wood, or pellets).

Racks of a cooking apparatus may be placed at various positions inside or above the cooking chamber depending on the amount of heat desired for cooking or warming the food. A user may place a rack closer to the heat source to impart a higher temperature to the food, such as when cooking the food. A user also may place a rack further from the heat source to impart less heat, and therefore a lower temperature to the food, such as when keeping the food warm before consuming it. Such a rack may be referred to as a “warming rack.”

Racks are usually held in place within a cooking apparatus by mounting the rack using a set of support brackets. The support brackets position the rack in the cooking apparatus but also allow the rack to be removed by a user, for instance, to reposition or clean the rack or remove food from the rack. For instance, traditional rack support brackets consist of a wide shelf and a lip positioned above the shelf, which together create a channel that the rack is slid into by the user. This design makes inserting and removing the rack easy for the user; however, this simple design comes with its disadvantages. For instance, when the user cleans the rack with a brush or tries to move food on and off it, the rack will slide around, making it harder to clean. Additionally, the rack will often be left crooked following use. If the rack is crooked, e.g., due to rotation or displacement from its original position, the lid or door of the cooking apparatus may hit it when the user tries to close the lid, preventing the cooking apparatus from closing.

Other rack supports for cooking apparatuses include hooks that hold the rack up along its edges. While these hooks solve the issue of the rack sliding around when cleaning or adding and removing food from it, the hooks also have their own disadvantages. For instance, it is far more difficult for the user to remove the rack from the hooks because, instead of sliding the rack out, the user is required to lift it straight off the hooks, which could result in the rack catching on one side. These difficulties are particularly concerning when the rack is hot, and the user may get burned or injured trying to remove a hot rack that gets caught. Additionally, because the hooks do not have the upper lip or channel design of a typical rack support bracket, if food sticks to the rack when the user tries to remove it, the user may inadvertently lift the rack off of the hooks.

Another technique for positioning a rack in a cooking apparatus does not use additional hardware mounted to the walls of the cooking chamber. Instead, the warming rack has “legs” that extend down and support the rack on another lower surface (such as a lower cooking rack). This technique has similar disadvantages as the previously mentioned rack positioning systems. Because the legged warming rack merely sits on a lower surface, if food sticks to it, the rack may be lifted off the surface when the user removes their food from the rack. The rack also is not held in place securely, so it can easily slide around when cleaning and may be slid into a position that would block the cooking apparatus from closing. Lastly, because it may sit directly on a lower grate, such as one reserved for cooking, it may decrease the cooking area of that lower grate.

Therefore, there is a need for an improved rack support system that keeps a rack in place while also allowing the user to easily insert and remove the rack, clean the rack, add or remove food from the rack, and close the lid of the cooking apparatus without impediment. Embodiments of the presently disclosed embodiments provide these and other advantages.

### SUMMARY OF THE DISCLOSED EMBODIMENTS

The disclosed embodiments comprise improved systems, methods, and apparatuses for securing and positioning a rack of a cooking apparatus. In the disclosed embodiments of the invention, a support shelf may extend horizontally from a side wall of a cooking apparatus, a guide shelf may be positioned above the support shelf, and a spring-biased element (such as a spring band or a spring-loaded assembly) may be disposed between the support shelf and the guide shelf. In some embodiments, the spring-biased element can be held in place by one or more slots disposed below the guide shelf. For example, when the spring-biased element comprises a spring band (e.g., a band or strip of spring steel or other material), the spring band may be shaped to curve toward the side wall at or near the distal ends of the spring band, i.e., having a center of curvature on or behind the side wall.

Further to the disclosed embodiments, a user may insert a rack on a pair of opposing support shelves, e.g., attached to opposing side walls of the cooking apparatus, each with a respective spring-biased element. In these disclosed embodiments, the pair of opposing support shelves and their spring-biased elements advantageously allow for “automatic” centering (e.g., self-centering) and securing of the rack in the cooking apparatus when in use, while still allowing easy insertion or removal of the rack by the user. The rack is automatically secured and substantially centered because it does not require additional manual action by the user to center and secure the rack after it has been inserted on the support shelves.

In some embodiments, a user can insert a rack in a cooking apparatus by positioning a side edge of the rack between the elongated support shelf and an associated guide shelf so that the side edge of the rack abuts a spring-biased element, such as a spring band. When the side edge of the rack contacts and compresses the spring-biased element, a counteracting spring force is applied to the side edge. Similarly, an opposite side edge of the rack may contact and compress another spring-biased element that is located between an elongated support shelf and a guide shelf on an opposite side wall of the cooking apparatus. These opposing spring forces applied to opposite side edges of the rack can ensure that the rack remains stable and substantially centered in the cooking apparatus. For example, when the user is removing food or cleaning the rack, the spring-biased elements may be compressed on both sides of the rack and apply counteracting spring forces on the sides of the rack to maintain the rack in a substantially centered position. The combination of the support shelf, the guide shelf, and spring-biased element on opposing side walls can secure the rack in place during ordinary use, while permitting a user to remove the rack with ease.

In some disclosed embodiments, the support shelf and guide shelf may be parallel to one another and extend perpendicularly from a backplate of a support bracket which, in turn, may be attached to a side wall of the cooking apparatus. The support shelf may be configured to extend further from the backplate than the guide shelf for greater surface area to support a rack. In some embodiments, the guide shelf may not be the same length as the support shelf to make it easier for the user to insert or remove a rack from above. Further, in other disclosed embodiments, the support shelf and guide shelf are not parallel and instead, for example, the guide shelf may be positioned at an upward angle with respect to the support shelf.

In some embodiments, the guide shelf may comprise two or more guide tabs positioned separately from one another. In some embodiments, the guide tabs may each comprise an opening, or slot, for receiving an end of a spring band so as to position the spring band at a desired radius of curvature when the ends of the spring band are inserted into the openings. In alternative embodiments, the ends of the spring band may be connected to a side wall of the cooking apparatus or to one or more receivers on the side wall.

In some embodiments, the systems and apparatuses disclosed herein may comprise a support bracket configured to be affixed to a side wall of a cooking apparatus to position and hold the rack with respect to a heat source. The support bracket may further comprise a backplate that can be attached to the side wall. In an exemplary embodiment, the support bracket may be affixed to a vertically-oriented (i.e., substantially vertical) side wall of a cooking apparatus, and therefore the backplate may be positioned on the vertically-oriented side wall. Further to the disclosed embodiments, the vertical backplate may comprise a plurality of holes for mounting the support bracket to a side wall of the cooking apparatus.

In some embodiments, one or more holes in the backplate may be generally keyhole shaped for securing the bracket to an interior surface of a side wall of the cooking chamber. The backplate may also comprise one or more generally horizontal “tabs” which extend in a substantially perpendicular direction from a bottom edge of the backplate in the opposite direction of the support shelf and guide shelf. In some disclosed embodiments, the interior wall of the cooking apparatus may have one or more slots designed to receive the tabs of the bracket and provide additional support for the bracket using a “tab and slot” mechanism.

In the disclosed embodiments, the rack may be supported by two support brackets with integrated spring bands mounted on opposite sides of the interior of the cooking chamber. The support brackets may be mounted at the same height to mirror each other. The spring bands within the two support brackets may apply a substantially equal and opposite force onto the side edges of the rack to automatically center and secure it.

Advantageously, the disclosed embodiments provide a rack support bracket with an integrated spring band (or other spring-biased element) that automatically centers and secures the rack, thus preventing the rack from shifting and/or rotating positions in the cooking apparatus and possibly blocking a lid or door of the cooking chamber from being fully closed unlike prior rack support systems. The rack support bracket disclosed herein therefore avoids the conventional difficulties of using prior rack support systems in cooking apparatuses.

### BRIEF DESCRIPTION OF THE DRAWINGS

The particular features and advantages of the invention will become apparent from the following description taken in connection with the accompanying drawings in which like reference numbers indicate identical or functionally similar elements. The following figures depict details of disclosed embodiments. The invention is not limited to the precise arrangement shown in these figures, as the accompanying drawings are provided merely as examples.

FIG. 1A is a perspective view of an exemplary cooking apparatus with the racks removed, which may be used in accordance with certain embodiments of the present invention.

FIG. 1B is a close-up perspective view of an exemplary support bracket mounted on a side wall of the cooking apparatus of FIG. 1A, which may be used in accordance with certain embodiments of the present invention.

FIG. 2 is a perspective view of a bracket body of an exemplary support bracket that may be used in accordance with certain embodiments of the present invention.

FIG. 3A is a perspective view of an exemplary spring band that may be used with the exemplary support bracket of FIG. 2 in accordance with certain embodiments of the present invention.

FIG. 3B is a top view of the exemplary spring band shown in FIG. 3A, which may be used in accordance with certain embodiments of the present invention.

FIG. 4A is a front perspective view of an exemplary support bracket that may be used in accordance with certain embodiments of the present invention.

FIG. 4B is a back perspective view of the exemplary support bracket of FIG. 4A, which may be used in accordance with certain embodiments of the present invention.

FIG. 4C is a top view of the exemplary support bracket of FIG. 4A, which may be used in accordance with certain embodiments of the present invention.

FIG. 4D is a bottom view of the exemplary support bracket of FIG. 4A, which may be used in accordance with certain embodiments of the present invention.

FIG. 4E is a rear view of the exemplary support bracket of FIG. 4A, which may be used in accordance with certain embodiments of the present invention.

FIG. 4F is a front view of the exemplary support bracket of FIG. 4A, which may be used in accordance with certain embodiments of the present invention.

FIG. 4G is a side profile view of the exemplary support bracket of FIG. 4A, which may be used in accordance with certain embodiments of the present invention.

FIG. 5 is an exploded view of the exemplary support bracket of FIGS. 4A-4G with respect to a side wall of an exemplary cooking apparatus of FIGS. 1A-1B, which may be used in accordance with certain embodiments of the present invention.

FIG. 6 is a perspective view of the side wall of the exemplary cooking apparatus of FIGS. 1A-1B with the support bracket removed, which may be used in accordance with certain embodiments of the present invention.

FIG. 7 is a perspective view of a rack mounted on two of the exemplary support brackets of FIGS. 4A-4B attached to opposing side walls of the exemplary cooking apparatus of FIGS. 1A-1B, which may be used in accordance with certain embodiments of the present invention.

FIG. 8 is a close-up view of an exemplary support bracket holding a rack, which may be used in accordance with certain embodiments of the present invention.

### DETAILED DESCRIPTION OF THE DISCLOSED EMBODIMENTS

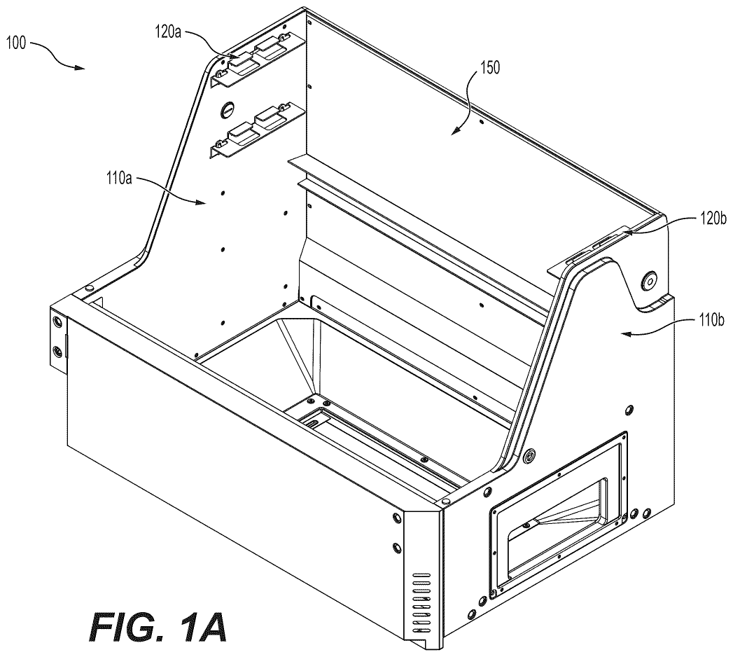

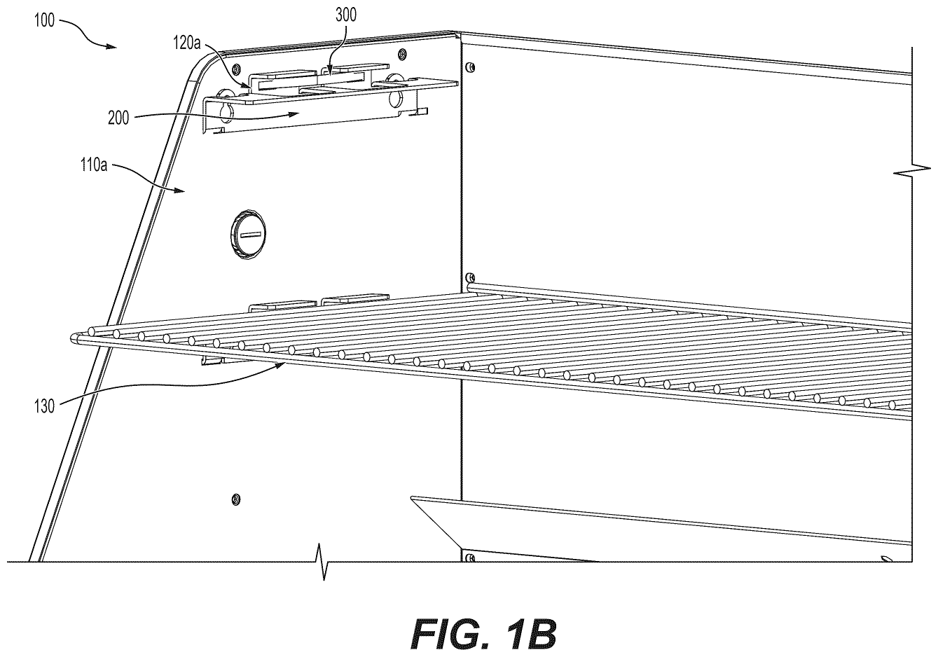

FIGS. 1-8 show various views of an example cooking apparatus 100, which may be a grill and/or smoker (hereinafter, “grill”), including support brackets 120a and 120b in accordance with certain embodiments of the present disclosure. Unlike prior rack support brackets for cooking apparatuses, the exemplary support brackets 120a and 120b are advantageous because they allow for “automatic” centering and securing of a rack in the grill when in use, while still allowing easy insertion or removal of the rack by the user. The rack is automatically secured and substantially centered because it does not require additional manual action by the user after the rack is inserted to center or secure it. While the presently described embodiments are shown in a grill, it is understood they can be applied to any cooking apparatus, including grills, smokers, ovens, or stoves, among others. Additionally, because the disclosed embodiments relate to an improved rack support system, the invention herein can be more generally applied in any device that includes a rack where it may be desirable to center and secure the rack in the device.

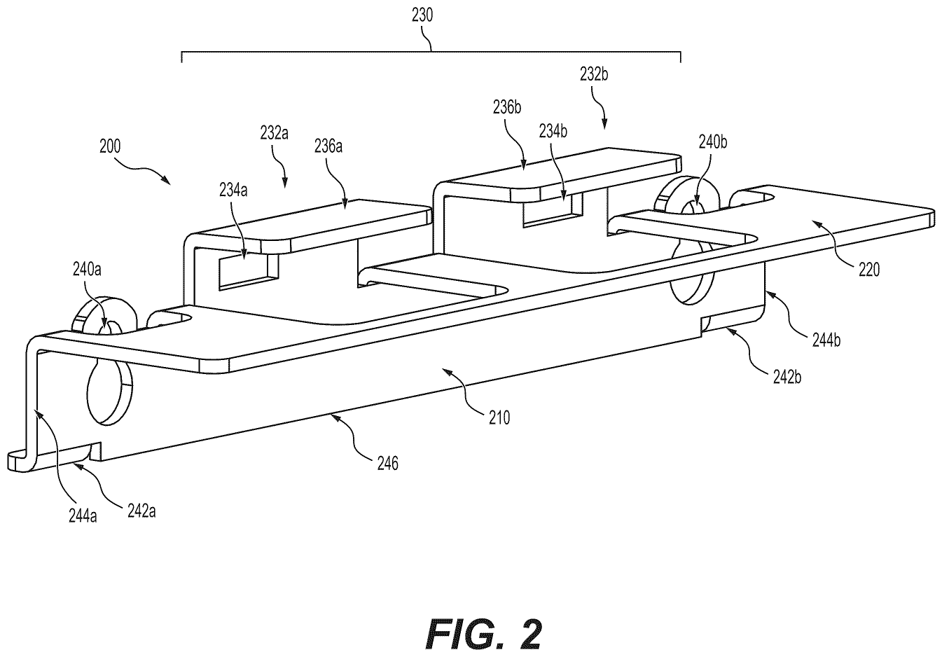

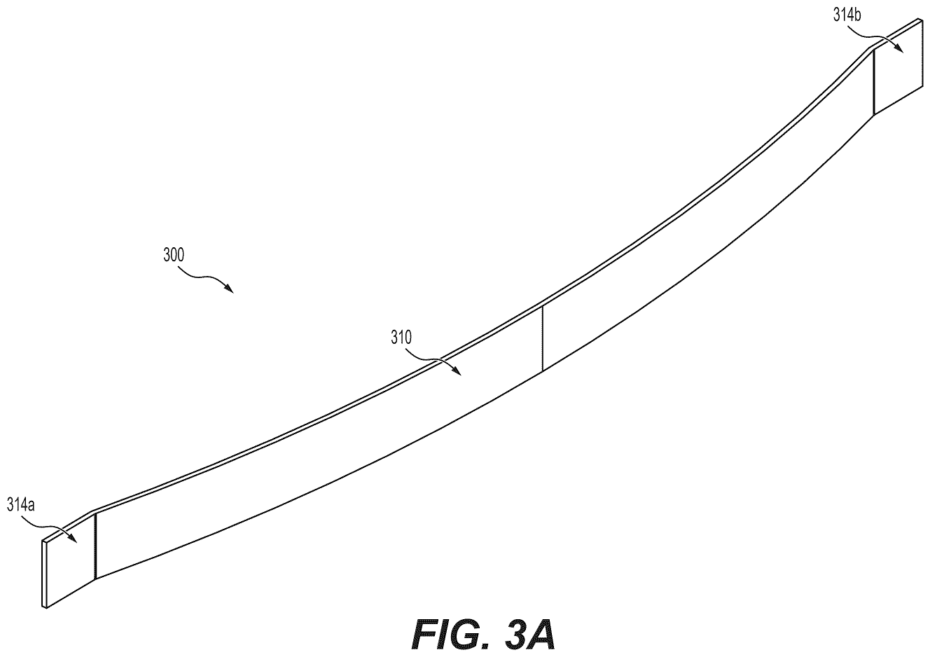

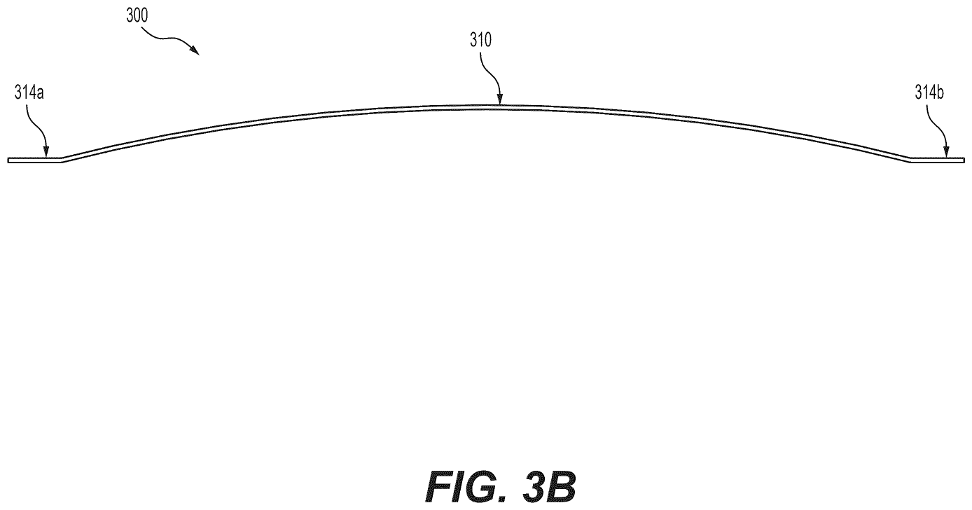

FIGS. 1A and 1B illustrate an exemplary cooking apparatus 100 having side walls 110a and 110b and opposing support brackets 120a and 120b mounted on corresponding side walls 110a and 110b. Cooking apparatus 100 may comprise one or more racks 130, which can be positioned and secured using the support brackets 120a and 120b within a cooking chamber 150 for cooking food. Each of the exemplary support brackets 120a and 120b comprises a bracket body 200 (illustrated in greater detail in FIG. 2) and a spring band 300 (illustrated in greater detail in FIGS. 3A and 3B). Support brackets 120a and 120b may be configured to receive a rack 130, such as a cooking rack or a warming rack, and substantially center and secure the rack within a cooking chamber 150 of the cooking apparatus 100 in order to cook or warm food.

FIG. 2 is a perspective view of bracket body 200 of the exemplary support brackets 120a and 120b shown in FIG. 1A. Bracket body 200 comprises a backplate 210 for mounting the bracket body 200 to a wall (such as side walls 110a, 110b) of the cooking apparatus 100. Bracket body 200 further comprises a support shelf 220 that extends substantially perpendicularly from backplate 210. Support shelf 220 may comprise a flat, elongated projection that is sized and shaped to support a side edge of the rack 130. Bracket body 200 further comprises a guide shelf 230 that is positioned above the support shelf 220. Support shelf 220 and guide shelf 230 may cooperate together to allow for insertion and removal of the rack 130.

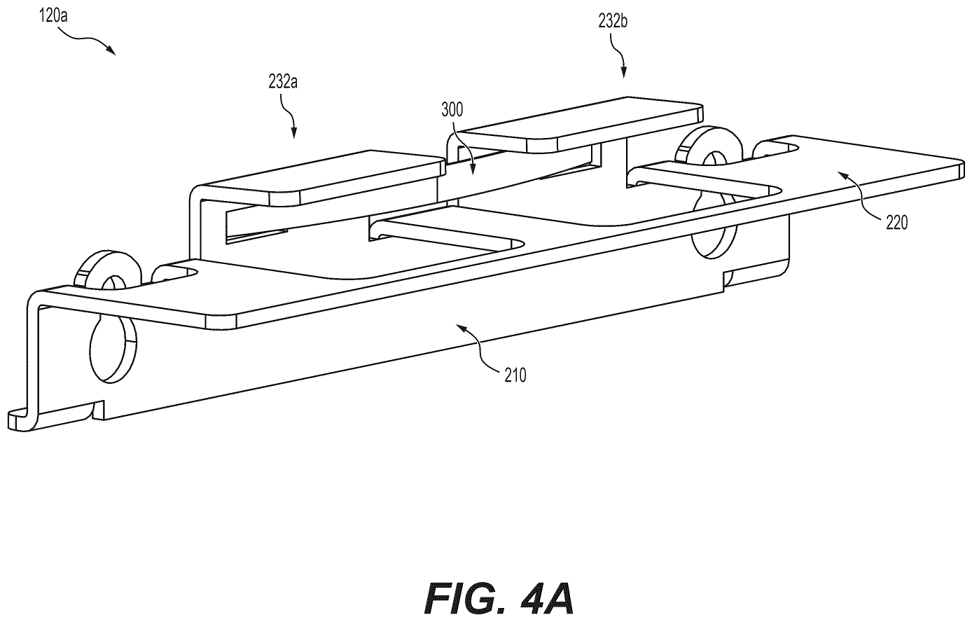

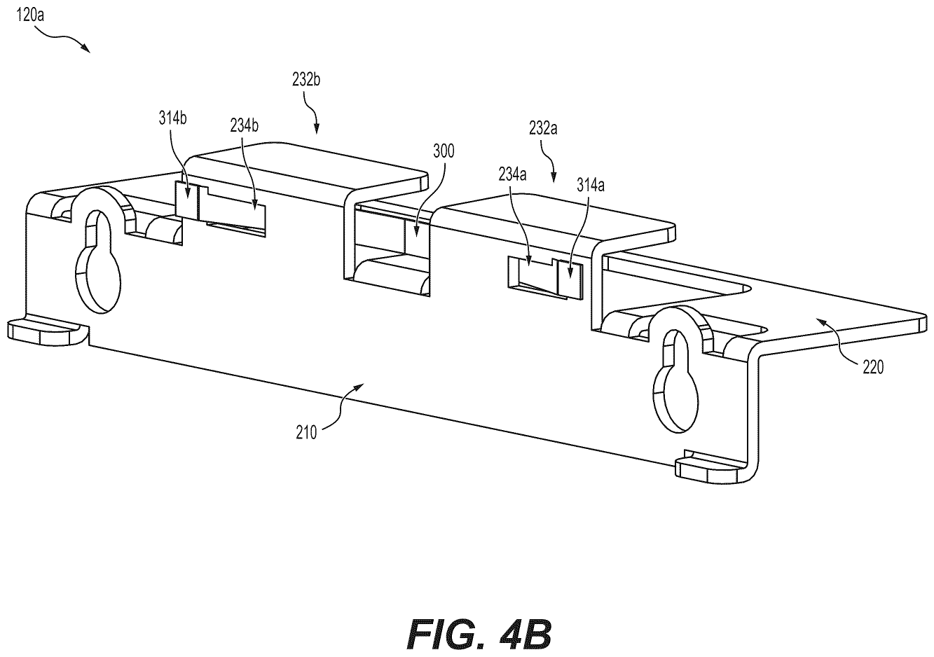

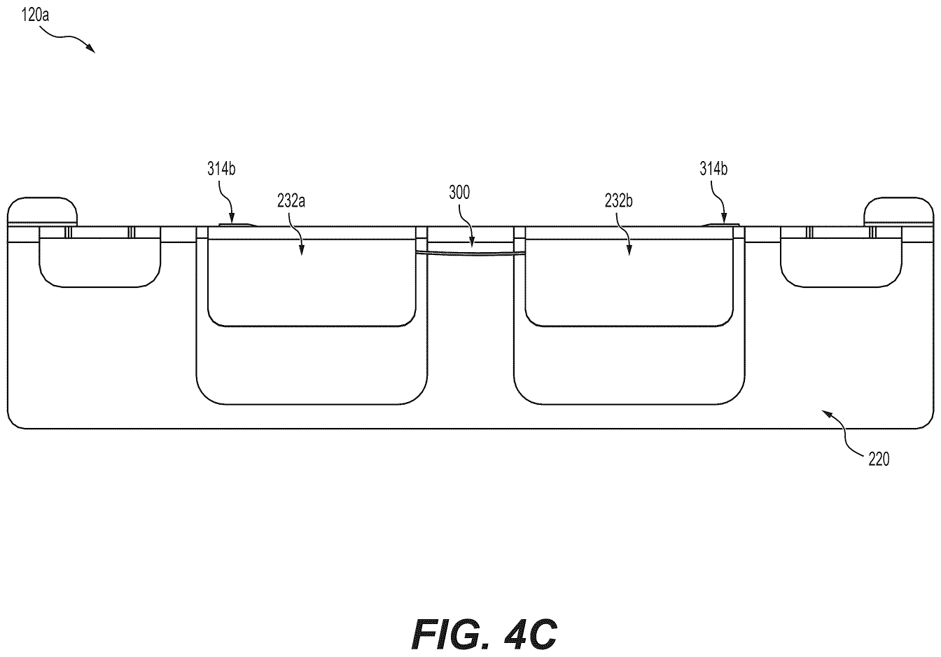

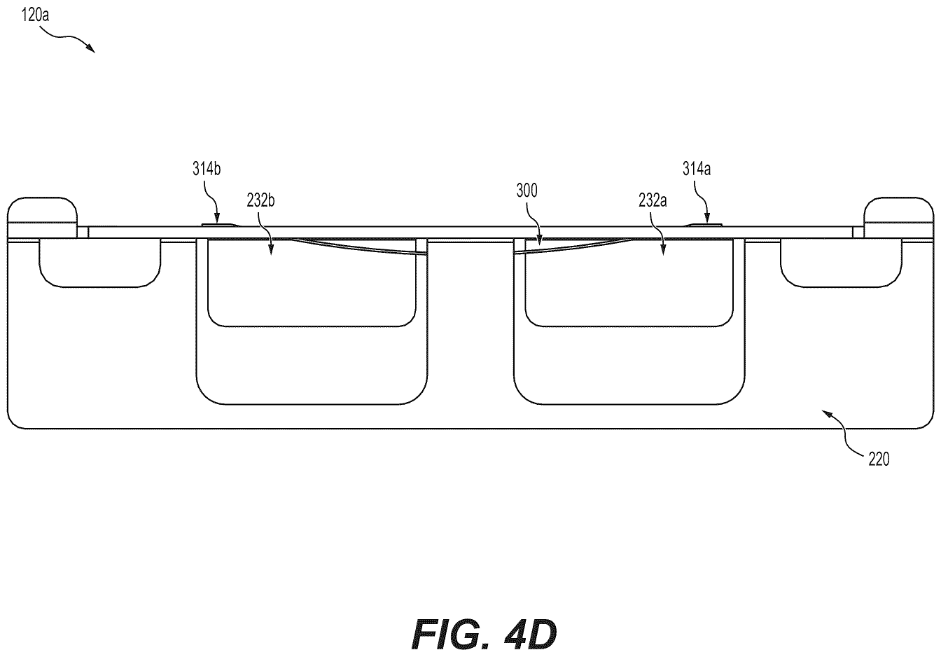

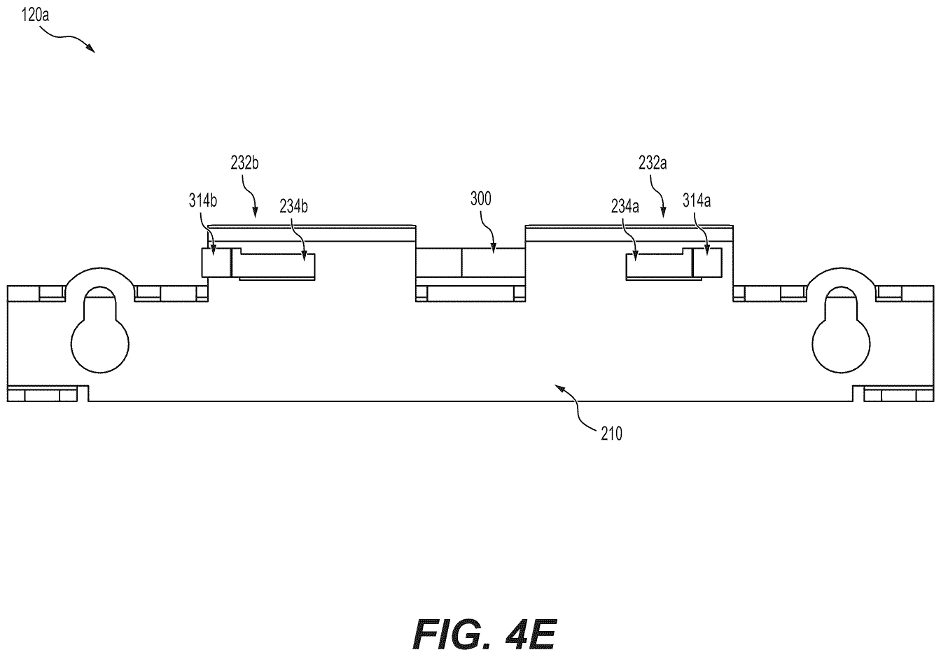

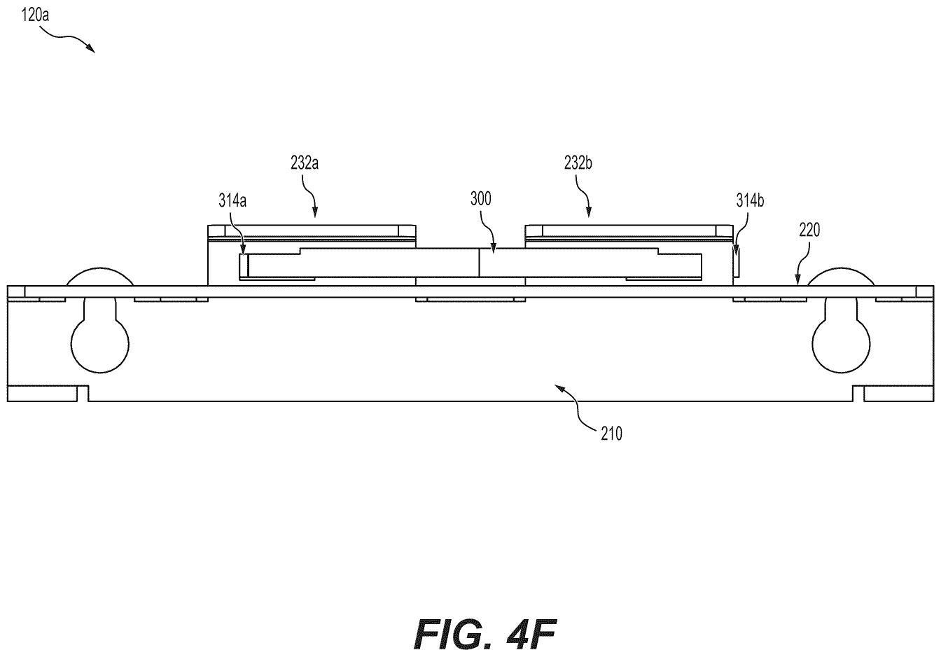

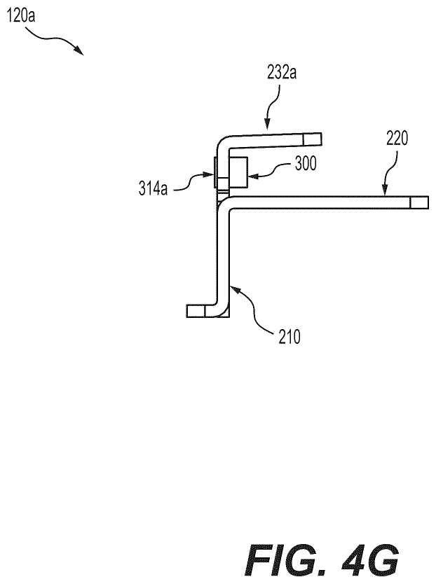

In some disclosed embodiments, as illustrated in FIG. 2, the guide shelf 230 may comprise two or more L-shaped guide tabs 232a and 232b that can be used to guide the rack 130 when it is inserted into support brackets 120a and 120b. The L-shaped guide tabs 232a and 232b may each further comprise an opening or slot 234a and 234b for receiving a spring band 300 (not shown in FIG. 2) as discussed in greater detail with respect to FIGS. 4A-4G. While the guide shelf 230 in FIG. 2 includes multiple guide tabs 232a and 232b and associated openings or slots 234a and 234b, in other embodiments (not shown) the guide shelf 230 instead may comprise only a single guide tab and/or a single opening or slot. For example, in some embodiments, the one or more openings or slots 234a and 234b may be formed in a backplate 210 or on another surface of the support brackets 120a and 120b.

In some disclosed embodiments, as illustrated in FIG. 2, a top surface 236a and 236b of guide tabs 232a and 232b may be positioned substantially parallel to the top surface of the support shelf 220. In other embodiments (not shown), the top surfaces 236a and 236b of the guide tabs 232a and 232b may be angled with respect to backplate 210, for example angled slightly upward or downward relative to the plane of the top surface of the support shelf 220. Similarly, in alternative embodiments where guide shelf 230 is not formed from a plurality of guide tabs and instead comprises a single surface, such a guide shelf 230 may be substantially horizontal or may be angled upward or downward with respect to the plane of the top surface of the support shelf 220.

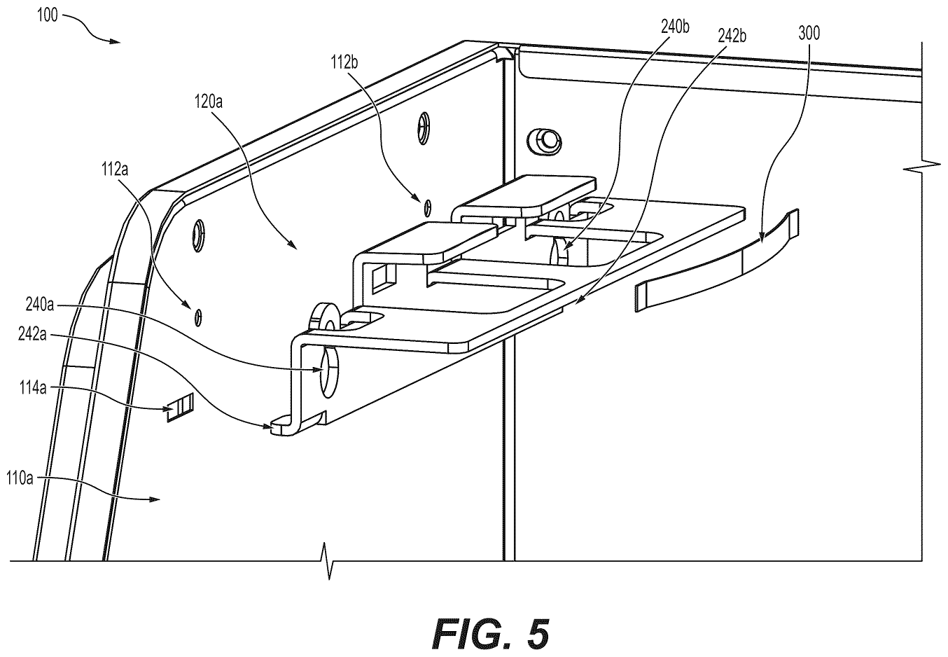

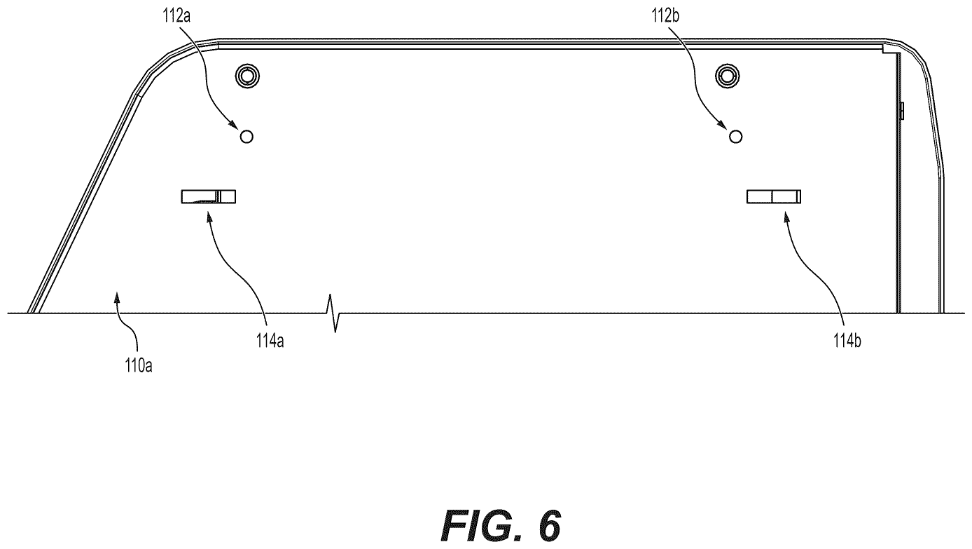

Bracket body 200 may further comprise one or more holes, such as holes 240a and 240b, and may comprise one or more tabs, such as tabs 242a and 242b, that may be used for securing bracket body 200 to the side wall 110a, 110b of a cooking apparatus 100 (as illustrated in FIGS. 5 and 6). For instance, as illustrated in FIG. 2, holes 240a and 240b may be keyhole-shaped and may be disposed on either side of a backplate 210 proximate to the respective side edges 244a and 244b of the backplate 210. In this example, the tabs 242a and 242b may extend horizontally away from a bottom edge 246 of the backplate 210 and in an opposite direction to support shelf 210 so they may be secured to a side wall 110a, 110b of cooking apparatus 100.

FIG. 3A is a perspective view of an exemplary spring band 300 that has been removed from the bracket body 200. Spring band 300 comprises an elongated body 310, wherein each end of the elongated body 310 may comprise a tab 314a and 314b. End tabs 314a and 314b can each be inserted within openings 234a and 234b of the guide tabs 132a and 132b respectively to hold the spring band 300 in place. In some embodiments, the end tabs 314a and 314b may be bent with respect to the elongated body 310, for example, in the same direction as the curvature of the elongated body 310.

Spring band 300 can be configured to apply a spring force to a side edge of the rack 130 when it is inserted between the support shelf 220 and guide shelf 230. The spring force from the spring band 300 may be used to secure and substantially center the rack 130 on the support brackets 120a and 120b and may also be used to re-position the rack 130 when an external force is applied to the rack. For instance, as illustrated in FIGS. 4A-4G, the end tabs 314a and 314b of the spring band 300 may be held in place within openings 232a and 232b such that spring band is curved outwardly from the bracket body 200. While the exemplary spring band 300 may be generally curved, e.g., as an arc of a circle or ellipse, those skilled in the art will appreciate that other shapes are possible for the spring band. For instance, a generally triangular, saw-tooth, sinusoidal, or other shaped spring band 300 (not shown) could similarly apply a spring force to a side edge of the rack 130. Accordingly, various shapes, thicknesses, sizes, and contours of the spring band 300 are contemplated so long as they make sufficient contact with the side edge of the rack 130 and apply a sufficient spring force to the rack consistent with the disclosed embodiments herein.

Spring band 300 may also be composed of any material, such as various elastic materials, that is able to substantially return to its original shape despite significant deflection or twisting, including but not limited to, spring steel. In other embodiments, spring band may comprise one or more springs or comprise another shape rather than curve, such as being flat, coiled, or a wave.

FIGS. 4A-4G show various views of the support bracket 120a, 120b having a spring band 300 inserted within bracket body 200. End tabs 314a and 314b of spring band 300 may be inserted in slots 232a and 232b of the L-shaped guide tabs 230a and 230b and may be held in place by catching (e.g., friction) on the edges of openings 232a and 232b. When held in place in the openings 232a and 232b, spring band 300 may be curved away from the backplate 210 into the cooking chamber 150. The distance between the openings 232a and 232b of the guide shelves 230a and 232b can also be adjusted as desired to change the radius of curvature of spring band 300. In some embodiments, the length of the spring band 300 may be selected to correspond to a desired radius of curvature of the spring band.

FIG. 5 is an exploded view of a support bracket 120a with respect to side wall 110a of cooking apparatus 100. FIG. 6 is a side view of the interior of a side wall 110a of cooking apparatus 100. As illustrated in FIGS. 5 and 6, side wall 110a may comprise a series of holes 112a, 112b and slots 114a, 114b for mounting and securing the support bracket 120a to side wall 110a. For instance, in order to secure support bracket 120a to side wall 110a, screws or bolts (or other fasteners) can be placed through key-hole shaped holes 240a and 240b and received in corresponding holes 112a and 112b. Additionally, in this exemplary disclosed embodiment, tabs 242a and 242b can be placed in corresponding slots 114a, 114b in side wall 110a. While FIGS. 5 and 6 show various features of one side wall 110 a of cooking apparatus 100, these features can also be present on an opposing side wall 110b of cooking apparatus 100 and with respect to support bracket 120b.

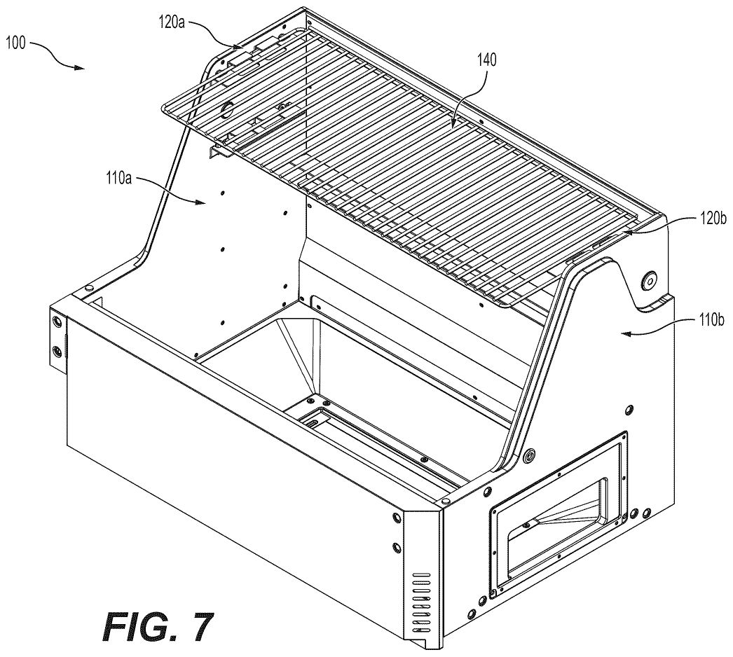

FIG. 7 is a perspective view of cooking apparatus 100 with a rack 140 held in place using a support bracket 120a affixed to a side wall 110a (such as illustrated in FIGS. 5 and 6) and an opposing support bracket 120b affixed to an opposing side wall 110b.

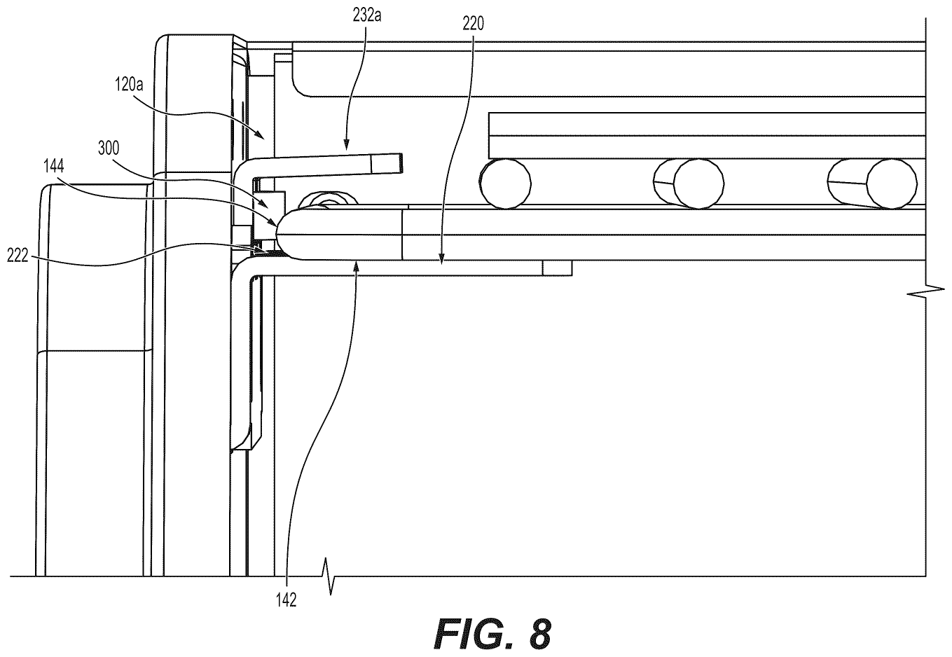

FIG. 8 is a close-up view of rack 140 positioned in support bracket 120a. In this example, when positioned in support bracket 120a, a bottom surface 142 of rack 140 rests on a top surface 222 of support shelf 220. A side edge 144 of rack 140 abuts spring band 300. When rack 140 is inserted into the cooking apparatus 100 using support bracket 120a, guide shelf 230 can help guide the rack 140 between guide tabs 232a, 232b and the support shelf 220. When rack 140 applies a compressive force to spring band 300, the spring band 300 will apply a counteracting spring force to recenter rack 140 on the support shelf 220. This may be useful in situations where rack 140 may become uncentered, for instance, when the rack 140 is cleaned, food is removed, or when the rack 140 is inserted or bumped during use.

Those skilled in the art will also appreciate that other modifications and alternatives may be implemented in accordance with the exemplary embodiments described herein. While this invention has been described with reference to certain disclosed embodiments thereof, it is to be understood that variations and modifications can be affected within the spirit and scope of the invention as described herein and as described in the appended claims. For example, while the disclosed embodiments employ an exemplary spring band on each rack support bracket, those skilled in the art will appreciate that other spring-biased elements, with or without any curvature, alternatively may be used within the scope of the invention. For instance, one or more of the exemplary spring bands could be replaced with a straight or curved piece of material (such as a plastic, aluminum, steel, etc.) having one or more springs positioned behind the piece of material for applying a spring force to an edge of a rack inserted into the support bracket.

Further, while the exemplary embodiments disclosed herein include a guide shelf 230 comprising multiple guide tabs 236a and 236b and multiple openings or holes 234a and 234b, in other alternative embodiments, the guide shelf 230 and support shelf 220 both may be elongated shelves that are respectively connected at or near the top and bottom of a backplane 210 and may be generally parallel to each other. In such embodiments, the guide shelf therefore may not comprise guide tabs. Further, a spring-biased element 300 may be positioned between the guide shelf 230 and support shelf 220 and may be connected to the backplate 210, for example, via one or more openings or holes in the backplane, or through any other attachment means. The backplate 210 may be configured to be attached to a wall of the cooking apparatus 100. Further, the guide shelf 230 and support shelf 220 may be mounted on a side wall of the cooking apparatus without a backplate and the spring-biased element 300 may be positioned on or in the side wall.

Accordingly, this description is to be taken only by way of example and not to otherwise limit the scope of the exemplary disclosed embodiments herein. Therefore, it is the object of the appended claims to cover all such variations and modifications as come within the true spirit and scope of the embodiments disclosed herein.

We claim:

1. A rack support system configured to position a rack on a side wall of a cooking apparatus, the rack support system comprising:
a support shelf extending horizontally with respect to a side wall of the cooking apparatus;
a guide shelf positioned above the support shelf; and
a spring-biased element positioned between the support shelf and the guide shelf, wherein the spring-biased element is curved with respect to the side wall of the cooking apparatus and is configured to apply a spring force to a side edge of the rack when the rack in inserted between the support shelf and the guide shelf.

2. The rack support system of claim 1, wherein the spring-biased element is a spring band.

3. The rack support system of claim 2, wherein the spring-biased element comprises spring steel.

4. The rack support system of claim 1, wherein the support shelf and the guide shelf are part of a support bracket comprising a backplate for affixing the support shelf and the guide shelf to the side wall of the cooking apparatus.

5. The rack support system of claim 4, wherein the guide shelf comprises at least two L-shaped guide tabs extending above the backplate.

6. The rack support system of claim 5, further comprising at least two slots positioned between a top surface of the guide tabs and the support shelf.

7. The rack support system of claim 6, wherein each slot is configured to receive a respective end of the spring-biased element in order to curve the spring-biased element with respect to the side wall of the cooking apparatus.

8. A rack support bracket for positioning a rack of a cooking apparatus, the rack support bracket comprising:
a backplate;
a support shelf extending perpendicularly from the backplate;
a guide shelf positioned above the support shelf;
at least two slots disposed between the support shelf and the guide shelf; and
a spring-biased element comprising two ends, wherein each end of the spring-biased element is disposed in a respective one of the at least two slots, such that the spring-biased element is curved outwardly from the backplate.

9. The rack support bracket of claim 8, wherein the backplate extends downwardly from the support shelf.

10. The rack support bracket of claim 8, wherein both ends of the spring-biased element comprise flat tabs.

11. The rack support bracket of claim 8, wherein the at least two slots are placed at a distance to maintain the curvature of the spring-biased element.

12. The rack support bracket of claim 8, wherein the spring-biased element comprises a spring band.

13. The rack support bracket of claim 12, wherein the spring band comprises spring steel.

14. The rack support bracket of claim 8, wherein the backplate further comprises at least one tab configured to secure the backplate in a corresponding opening in a side wall of the cooking apparatus.

15. A cooking apparatus comprising:
a pair of opposing side walls;
a pair of rack support brackets for receiving a rack, wherein each support bracket is affixed to a side wall of the pair of opposing side walls, wherein each support bracket comprises:
a backplate;
a support shelf extending perpendicularly from the backplate;
a guide shelf positioned above the shelf;
at least two slots disposed between the support shelf and the guide shelf; and
a spring-biased element comprising two ends, wherein each end of the spring-biased element is disposed in at least one of the at least two slots, such that the spring-biased element is curved outwardly from the backplate.

16. The cooking apparatus of claim 15, wherein the cooking apparatus is a grill and smoker.

17. The cooking apparatus of claim 15, wherein the at least two slots are placed at a distance to maintain the curvature of the spring-biased element.

18. The cooking apparatus of claim 15, wherein the spring-biased element comprises a spring band.

19. The cooking apparatus of claim 18, wherein the spring band comprises spring steel.

20. The cooking apparatus of claim 15, wherein the backplate of each rack support bracket further comprises at least one tab configured to secure the backplate in a corresponding opening in the side wall of the cooking apparatus.
